(19) United States
(12) Patent Application Publication
(10) Pub. No.: US 2021/0365153 A1
(43) Pub. Date: Nov. 25, 2021

(54) TOUCH DISPLAY PANEL AND DISPLAY DEVICE

(71) Applicant: WUHAN CHINA STAR OPTOELECTRONICS DISPLAY TECHNOLOGY CO., LTD., Wuhan, Hubei (CN)

(72) Inventor: Xiaoliang FENG, Wuhan, Hubei (CN)

(21) Appl. No.: 16/494,872

(22) PCT Filed: Mar. 15, 2019
(86) PCT No.: PCT/CN2019/078289

§ 371 Date: Sep. 17, 2019

(30) Foreign Application Priority Data
Oct. 31, 2018 (CN) 201811285158.2

(51) Int. Cl. G06F 3/044; G06F 3/041

(52) U.S. Cl. CPC G06F 3/0446; G06F 2203/04111; G06F 3/04164; G06F 3/0412

(57) ABSTRACT

The present application provides a touch display panel, including a substrate, multiple electrodes disposed on the substrate, and a driver chip. The electrode is connected to the driver chip by a wiring, wherein at least part of the wiring and the electrode are located in different layers.

### BACKGROUND OF THE INVENTION

### 1. Field of the Invention

The present application relates to a display technology field, and more particularly to a touch display panel and a display device.

### 2. Description of the Prior Art

A touch display panel is the latest computer input device. It is a simplest, convenient and natural way of human-computer interaction. As the new appearance of multimedia, it is an attractive new multimedia interactive device.

Please refer to FIG. 1, it shows a structure schematic view of a touch display panel in the prior art. The prior touch display panel includes a substrate 10, multiple first electrodes 201 disposed on the substrate 10, multiple second electrodes 202 disposed on the substrate 10, and a driver chip 30. Normally, each first electrode 201 is connected to the driver chip by one first wiring 401 set outside a touch area, and each second electrode 202 is connected to the driver chip 30 by one second wiring 402 set outside the touch area.

With the improvement of the accuracy of the touch display panel, the number of the first and second electrodes will also increase. Correspondingly, the number of the first and second wirings is increasing, and then a border area of the touch display panel must be increased for increasing a wiring area. Therefore, it is not conducive to achieving the desired narrow border design effect.

### 3. Technical Problem

A main technical problem solved in this application is how to increase a wiring area without increasing a border area.

### BRIEF SUMMARY OF THE INVENTION

On the first hand, the application provides a touch display panel, comprising:

a substrate; multiple electrodes disposed on the substrate; and a driver chip. The electrode is connected to the driver chip by a wiring, wherein at least part of the wiring and the electrode are located in different layers, and a projection of the part of the wiring on the substrate coincides with that of the electrode on the substrate.

The electrodes includes multiple first electrodes and multiple second electrodes; the multiple first electrodes are electrically connected in a first direction to form a first electrode chain; the multiple second electrodes are electrically connected in a second direction to form a second electrode chain; the wiring includes a first wiring and a second wiring.

The first electrode chain and the second electrode chain are crossed;

wherein the first electrode chain is connected to the driver chip by the first wiring; the second electrode chain is connected to the driver chip by the second wiring; and the first wiring and the first electrode are located in different layers.

In the embodiment of the touch display panel, a projection of the second electrode connected with the second wiring on the substrate coincides with that of the first wiring on the substrate.

In the embodiment of the touch display panel, the first electrode is provided with a connection hole, and the first wiring is connected with the first electrode by the connection hole.

In the embodiment of the touch display panel, the touch display panel further includes multiple conductive bridges, which are arranged along the second direction; the conductive bridge and the second electrode are disposed in different layers, and the conductive bridge and the first wiring are located in the same layer;

wherein two adjacent second electrodes are connected together through one conductive bridge.

In the embodiment of the touch display panel, the first wiring, the second wiring and the conductive bridge are disposed in the same layer;

wherein the second wiring extends along the first direction and arranged along the second direction.

In the embodiment of the touch display panel, the first wiring and the second wiring are located in different layers;

Wherein the second wiring extends along the first direction and arranged along the second direction.

In the embodiment of the touch display panel, an insulation layer is formed between the first electrode and the conductive bridge adjacent to the first electrode, to insulate the first electrode and the conductive bridge from each other.

On the second hand, the application provides a touch display panel, comprising:

a substrate; multiple electrodes disposed on the substrate; and a driver chip. The electrode is connected to the driver chip by a wiring, wherein at least part of the wiring and the electrode are located in different layers.

In the embodiment of the touch display panel, a projection of the part of the wiring on the substrate coincides with that of the electrode on the substrate.

In the embodiment of the touch display panel, the electrodes includes multiple first electrodes and multiple second electrodes; the multiple first electrodes are electrically connected in a first direction to form a first electrode chain; the multiple second electrodes are electrically connected in a second direction to form a second electrode chain; the wiring includes a first wiring and a second wiring;

The first electrode chain and the second electrode chain are crossed;

wherein the first electrode chain is connected to the driver chip by the first wiring; the second electrode chain is connected to the driver chip by the second wiring; and the first wiring and the first electrode are located in different layers.

In the embodiment of the touch display panel, a projection of the second electrode connected with the second wiring on the substrate coincides with that of the first wiring on the substrate.

In the embodiment of the touch display panel, the first electrode is provided with a connection hole, and the first wiring is connected with the first electrode by the connection hole.

In the embodiment of the touch display panel, the touch display panel further includes multiple conductive bridges, which are arranged along the second direction; the conductive bridge and the second electrode are disposed in different layers, and the conductive bridge and the first wiring are located in the same layer;

wherein two adjacent second electrodes are connected together through one conductive bridge.

In the embodiment of the touch display panel, the first wiring, the second wiring and the conductive bridge are disposed in the same layer;

wherein the second wiring extends along the first direction and arranged along the second direction.

In the embodiment of the touch display panel, wherein the first wiring and the second wiring are located in different layers;

wherein the second wiring extends along the first direction and arranged along the second direction.

In the embodiment of the touch display panel, an insulation layer is formed between the first electrode and the conductive bridge adjacent to the first electrode, to insulate the first electrode and the conductive bridge from each other.

On the second hand, the application provides a display device, comprising a touch display panel, which includes:

a substrate; multiple electrodes disposed on the substrate; and a driver chip. The electrode is connected to the driver chip by a wiring, wherein at least part of the wiring and the electrode are located in different layers.

In the embodiment of the display device, a projection of the part of the wiring on the substrate coincides with that of the electrode on the substrate.

In the embodiment of the display device, the electrodes includes multiple first electrodes and multiple second electrodes; the multiple first electrodes are electrically connected in a first direction to form a first electrode chain; the multiple second electrodes are electrically connected in a second direction to form a second electrode chain; the wiring includes a first wiring and a second wiring;

the first electrode chain and the second electrode chain are crossed;

wherein the first electrode chain is connected to the driver chip by the first wiring; the second electrode chain is connected to the driver chip by the second wiring; and the first wiring and the first electrode are located in different layers.

The beneficial effect of the application is that the partial wiring and the electrode are disposed in different layers, so a wiring area is enlarged without increasing a border area, and the technical problem of larger border area of the prior touch display panel is solved.

### BRIEF DESCRIPTION OF THE DRAWINGS

For more clearly illustrating the technical scheme in the embodiment of the present application or the prior art, the following text will briefly introduce the accompanying drawings used in the embodiment and the prior art. It is obvious that the accompanying drawings in the following description are only some embodiments of the present application. For the technical personnel of the field, other drawings can also be obtained from these drawings without paying creative work.

FIG. 1 is a structure schematic view of a touch display panel in the prior art;

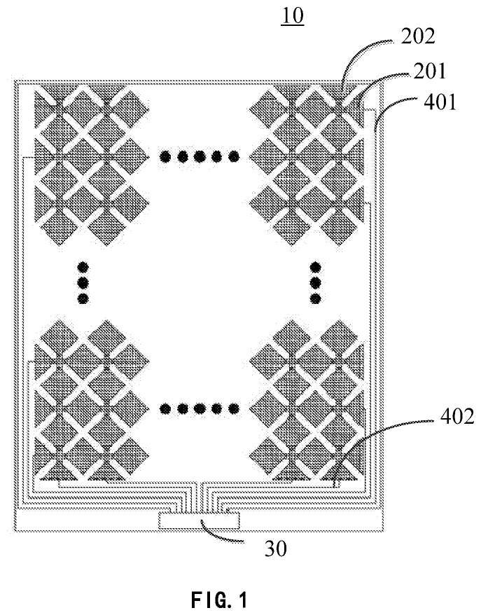

FIG. 2 is a structure schematic view of a touch display panel provided in one embodiment of the present application;

FIGS. 3 and 4 show an enlarged schematic view of a connection position of a first wiring and a first electrode;

FIG. 5 is an enlarged schematic view of a connection position of a second wiring and a second electrode; and

FIG. 6 is a sectional view of the touch display panel provided in one embodiment of the present application.

### DETAILED DESCRIPTION OF THE PREFERRED EMBODIMENTS

The following text will describe embodiments of the present application in detailed. The embodiments are shown in the accompanying drawings, in which the same or similar signs represent the same or similar elements or elements with the same or similar functions from beginning to end. The following embodiments described with reference to the accompanying drawings are illustrative and are intended only to explain the present application and are not understood as limitations to the application.

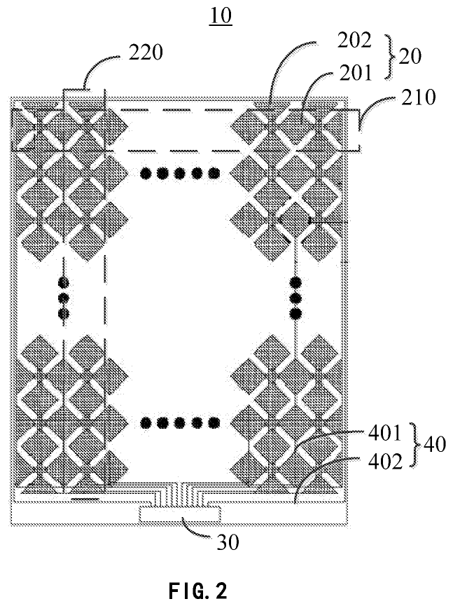

Please refer to FIG. 2, it shows a structure schematic view of a touch display panel provided in one embodiment of the present application.

The embodiment of the present application provides a touch display panel, which includes:

a substrate 10; multiple electrodes 20 disposed on the substrate 10; and a driver chip 30.

The electrode 20 is connected to the driver chip 30 by a wiring 40. Wherein, at least part of the wiring 40 and the electrode 20 are located in different layers.

For example, the substrate 10 may be a glass substrate, a high thermal conductivity aluminum substrate or a polyimide (PI) substrate, or may be a Thin Film Transistor (TFT) substrate or an Organic Light Emitting Diode (OLED) substrate. The electrodes 20 include multiple driver electrodes and multiple sense electrodes. The electrodes 20 are connected to the driver chip 30 by the wiring 40, and at least part of the wiring 40 and the electrode 20 are located in different layers.

Moreover, in some embodiments, a projection of the part of the wiring 40 on the substrate 10 coincides with that of the electrode on the substrate.

Please continue to refer to FIG. 2, the electrodes 20 includes multiple first electrodes 201 and multiple second electrodes 202. The multiple first electrodes 201 are electrically connected together in a first direction to form a first electrode chain 210. The multiple second electrodes 202 are electrically connected together in a second direction to form a second electrode chain 220. The wiring 40 include a first wiring 401 and a second wiring 402.

The first electrode chain 210 and the second electrode chain 220 are crossed. The first electrode chain 210 is connected to the driver chip 30 by the first wiring 401, and the second electrode chain 220 is connected to the driver chip 30 by the second wiring 402. The first wiring 401 and the first electrode 201 are located in different layers.

The first electrode 201 may be a sense electrode or a driver electrode. Similarly, the second electrode 202 also may be a sense electrode or a driver electrode. The specific selection is set according to the actual situation. The first electrodes 201 are arranged along the first direction, and form the first electrode chain 210 in the first direction. The second electrodes 202 are arranged along the second direction, and form the second electrode chain 220 in the second direction. Wherein, the first electrode chain 210 and the second electrode chain 220 are crossed. Namely, the first direction and the second direction are crossed. Specifically, the first electrodes 201 are arranged in M rows, and in the second electrodes 202 are arranged in N columns, wherein M and N are positive integers greater than or equal to one. Referring to FIG. 2, in the embodiment of the present application, the first direction means an arrangement direction of one row of the first electrodes 201, and the second direction means an arrangement direction of one column of the second electrodes 202. The positions of the first and second electrodes 201, 202 in FIG. 2 are merely illustrative, not restrictive to this application.

Furthermore, in the embodiment of this application, the first wiring 401 and the first electrode 201 are located in different layers. Specifically, the first wiring 401 is drawn from the inside of the first electrode 201 and is connected with the driver chip 30. The first wiring 401 extends along the second direction and arranged along the first direction. The second wiring 402 is drawn from the inside of the second electrode 202 and is connected with the driver chip 30.

In the embodiment of the application, the first wiring 401 and the first electrode 201 are disposed in different layers, which can increase a wiring area without increasing a border area, thus solving the technical problem of larger border area of the prior touch display panel.

In some embodiments, a projection of the second electrode 202 connected with the second wiring 402 on the substrate 10 coincides with that of the first wiring 401 on the substrate 10.

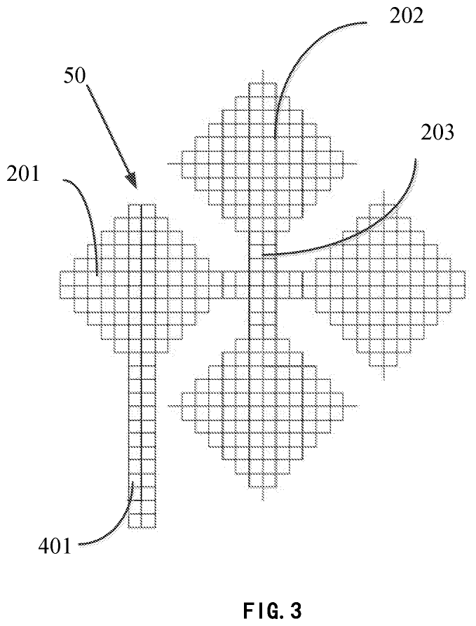

In some embodiments, please refer to FIGS. 3 and 4, the first electrode 201 is connected with the first wiring 401 by a connection hole 50 formed on the first electrode 201. Namely, the first electrode 201 is provided with the connection hole 50, the first wiring 401 is connected with the first electrode 201 through the connection hole 50. Wherein, according to a distance between the connection hole 50 and the driver chip 30, the first wiring 401 is arranged along the second direction in order from far to near.

Specifically, the first electrode 201 is provided with one connection hole 50, the first wiring 401 is drawn from the connection hole 50, and the first electrode 201 is connected to the driver chip 30 through the first wiring 401. In the second direction, the connection holes formed in one first electrode 201 of row M and formed in one first electrode 201 of row M−1 are not in the same straight line of the second direction; and the connection holes formed in one first electrode 201 of row M−1 and formed in one first electrode 201 of row M−2 are also not in the same straight line. By analogy, this wiring way facilitates the arrangement of the first wiring 401, which will not be repeated here.

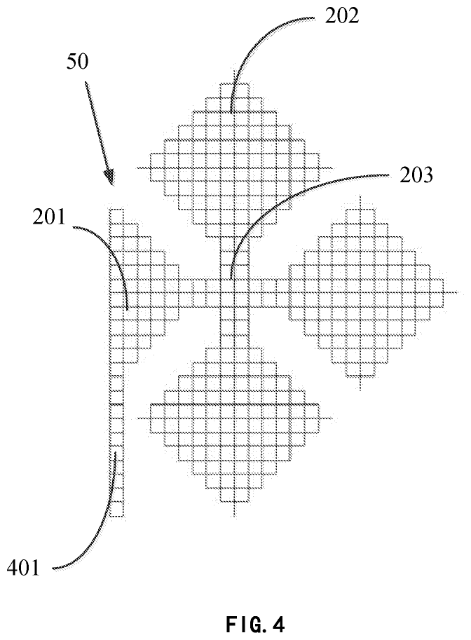

Please refer to FIGS. 3 to 5, in some embodiments of the present application, the touch display panel further includes:

multiple conductive bridges 203, being arranged along the second direction. The conductive bridge 203 and the second electrode 202 are disposed in different layers, and the conductive bridge 203 and the first wiring 401 are located in the same layer. Wherein, two adjacent second electrodes 202 are connected together through one conductive bridge 203.

Specifically, two adjacent second electrodes 202 are electrically connected together through one conductive bridge 203, so that the second electrodes 202 in the same column can transmit signals to the driver chip 30 through the second wiring 402. It should be noted that, the conductive bridge 203 is a cross-wire structure, which enables the connection between the two adjacent second electrodes 202 to avoid the first electrode 201.

In some embodiments, the first wiring 401, the second wiring 402 and the conductive bridge 203 can be disposed in the same layer. Wherein, the second wiring 402 extends along the first direction, and arranged along the second direction.

Wherein, because the first direction and the second direction are crossed, the first wiring 401 and the second wiring 402 are at least partially crossed in different planes. Further, the first wiring 401 are at least partially perpendicular to the second wiring 402. In the embodiment, the first wiring 401 and the second wiring 402 are at least partially crossed in different planes, which means that the projections of the first wiring 401 and the second wiring 402 on the substrate 10 are intersected with each other, but does not mean that the first wiring 401 and the second wiring 402 are actually intersected with each other in the same plane. In other words, the first wiring 401 are perpendicular to the second wiring 402, which also means that the projections of the first wiring 401 and the second wiring 402 on the substrate 10 are perpendicular in part.

In some embodiments, the first wiring 401 and the second wiring 402 are located in different layers. Wherein the second wiring 402 extends along the first direction, and arranged along the second direction.

Wherein, the first wiring 401 and the conductive bridge 203 are located in the same layer, please see above description for details. In the embodiment, the first wiring 401 and the second wiring 402 are located in different layers. That is, the second wiring 402, the first electrode 201 and the second electrode 202 are located in the same layer. In another embodiment, the second wiring 402 can not be disposed on the same layer as the first electrode 201, the second electrode 202 and the first wiring 401. A wiring way of the second wiring 401 is the same as that of the previous embodiment, and will not be repeated here.

Moreover, the wiring way of the second wiring 401 can be set by combining the preceding two embodiments. For example, one part of the second wiring 402 is disposed in the same layer as the first wiring 401 and the conductive bridge 203, and the other part of the second wiring 402 is disposed in the different layer from the first wiring 401 and the conductive bridge 203, thereby not only facilitating the arrangement of the second wiring 402, but also enlarging a gap between the first wiring 401 and the second wiring 402 and reducing the probability of interference between the first wiring 401 and the second wiring 402. A specific wiring way of the second wiring 401 is the same as that of the previous embodiment, and will not be repeated here.

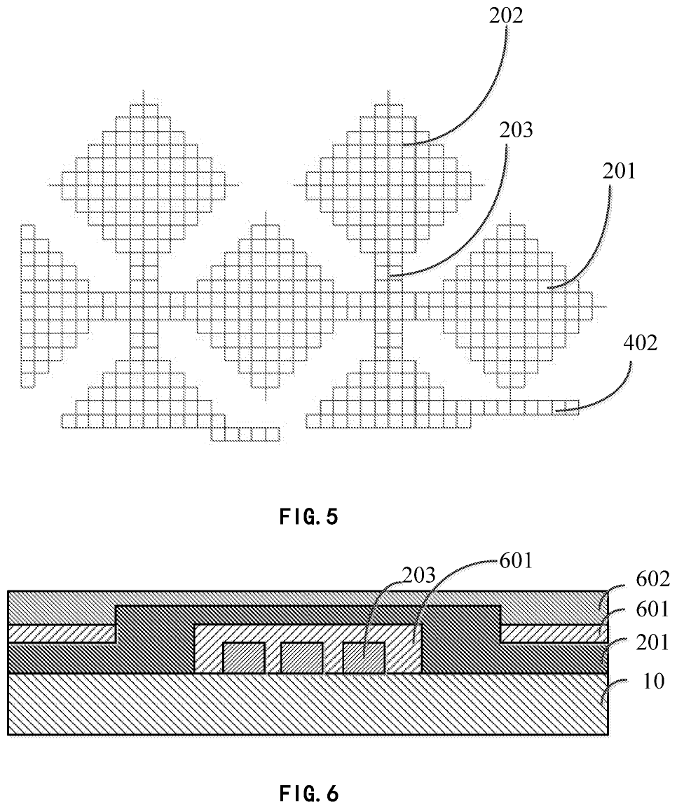

Please refer to FIG. 6, there is an insulation layer 601 between the first electrode 201 and the conductive bridge 203 adjacent to the first electrode 201, to insulate the first electrode 201 and the conductive bridge 203 from each other.

Take the first electrode 201 as the sense electrode and take the second electrode 202 as the driver electrode as an example to illustrate. Specifically, the second electrode 202 is used to receive a touch driving signal, and the first electrode 201 is used to generate a touch sense signal. A coupling capacitance can be generated near the first electrode 201 and the second electrode 202. When the human body touches the touch display panel, due to the grounding of the human body, a capacitance in series with the coupling capacitance will be formed between the human finger and the display panel, which will reduce the capacitance detected by the first electrode 201 and generate the corresponding touch sense signal. A specific touching position of the touch display panel can be determined by converting the touch sense signal. Therefore, in order to insulate the first electrode 201 and conductive bridge 203, the insulation layer 601 is disposed between the first electrode 201 and the conductive bridge 203, which are adjacent. In some embodiments, a protective layer 602 is further disposed on the first electrode 201 and the second electrode 202 to protect the first and second electrodes 201, 202, for making the first electrode 201 and the second electrode 202 insulated from other films.

In some embodiment, the first electrode 201, the second electrode 202 and the conductive bridge 203 are all grid structures.

For example, the first electrode 201, the second electrode 202 and the conductive bridge 203 can be set as grid metal wires. On the one hand, the impedance of the first electrode 201 and the second electrode 202 can be reduced, and the touch sensitivity of the touch display panel can be improved. On the other hand, the ductility of the grid metal wires is good, and the bending ability of the touch display panel can be further improved.

In some embodiments, the grid conductive bridge 203 at least partially coincides with the grid second electrode 202.

In some embodiments, the material of the first wiring 401 and the second wiring 402 is transparent oxide.

In some embodiments, the material of the first wiring 401 is the same as that of the second wiring 402, which is indium tin oxide, so as to avoid reducing the opening rate of the touch display panel.

Correspondingly, the present application further provides a display device, including the touch display panel of any one embodiment.

In the embodiment, by extending the first wiring 401 along the second direction, arranging the first wiring 401 in columns along the first direction, and setting the first wiring 401 and the first electrode 201 in different layers, the wiring area is enlarged without increasing the border area, and the technical problem of larger border area of the prior touch display panel is solved.

The above description of the touch display panel provided by the embodiment of the application is described in detail. In above text, the principles and implementation mode of the present application are expounded with specific examples, and above specific examples are only for helping to understand the application. Moreover, for those of ordinary skill in the art, there will be changes in the specific implementation and application scope according to the ideas of the present application. In summary, the content of this specification should not be understood as a limitation to the present application.

What is claimed is:

1. A touch display panel, comprising:
a substrate;
multiple electrodes disposed on the substrate; and
a driver chip; the electrode being connected to the driver chip by a wiring, wherein at least part of the wiring and the electrode being located in different layers, and a projection of the part of the wiring on the substrate coinciding with that of the electrode on the substrate;
the electrodes including multiple first electrodes and multiple second electrodes; the multiple first electrodes being electrically connected in a first direction to form a first electrode chain; the multiple second electrodes being electrically connected in a second direction to form a second electrode chain; the wiring including a first wiring and a second wiring;
the first electrode chain and the second electrode chain being crossed;
wherein the first electrode chain is connected to the driver chip by the first wiring; the second electrode chain is connected to the driver chip by the second wiring; and the first wiring and the first electrode are located in different layers.

2. The touch display panel as claimed in claim 1, wherein a projection of the second electrode connected with the second wiring on the substrate coincides with that of the first wiring on the substrate.

3. The touch display panel as claimed in claim 2, wherein the first electrode is provided with a connection hole, and the first wiring is connected with the first electrode by the connection hole.

4. The touch display panel as claimed in claim 3, wherein the touch display panel further includes multiple conductive bridges, which are arranged along the second direction; the conductive bridge and the second electrode are disposed in different layers, and the conductive bridge and the first wiring are located in the same layer;
wherein two adjacent second electrodes are connected together through one conductive bridge.

5. The touch display panel as claimed in claim 4, wherein the first wiring, the second wiring and the conductive bridge are disposed in the same layer;
wherein the second wiring extends along the first direction and arranged along the second direction.

6. The touch display panel as claimed in claim 4, wherein the first wiring and the second wiring are located in different layers;
wherein the second wiring extends along the first direction and arranged along the second direction.

7. The touch display panel as claimed in claim 4, wherein an insulation layer is formed between the first electrode and the conductive bridge adjacent to the first electrode, to insulate the first electrode and the conductive bridge from each other.

8. A touch display panel, comprising:
a substrate;
multiple electrodes disposed on the substrate; and
a driver chip; the electrode being connected to the driver chip by a wiring, wherein at least part of the wiring and the electrode are located in different layers.

9. The touch display panel as claimed in claim 8, wherein a projection of the part of the wiring on the substrate coincides with that of the electrode on the substrate.

10. The touch display panel as claimed in claim 9, wherein the electrodes includes multiple first electrodes and multiple second electrodes; the multiple first electrodes are electrically connected in a first direction to form a first electrode chain; the multiple second electrodes are electrically connected in a second direction to form a second electrode chain; the wiring includes a first wiring and a second wiring;
the first electrode chain and the second electrode chain are crossed;
wherein the first electrode chain is connected to the driver chip by the first wiring; the second electrode chain is connected to the driver chip by the second wiring; and the first wiring and the first electrode are located in different layers.

11. The touch display panel as claimed in claim 10, wherein a projection of the second electrode connected with the second wiring on the substrate coincides with that of the first wiring on the substrate.

12. The touch display panel as claimed in claim 11, wherein the first electrode is provided with a connection hole, and the first wiring is connected with the first electrode by the connection hole.

13. The touch display panel as claimed in claim 12, wherein the touch display panel further includes multiple conductive bridges, which are arranged along the second direction; the conductive bridge and the second electrode are disposed in different layers, and the conductive bridge and the first wiring are located in the same layer;
wherein two adjacent second electrodes are connected together through one conductive bridge.

14. The touch display panel as claimed in claim 13, wherein the first wiring, the second wiring and the conductive bridge are disposed in the same layer;
wherein the second wiring extends along the first direction and arranged along the second direction.

15. The touch display panel as claimed in claim 13, wherein the first wiring and the second wiring are located in different layers;
wherein the second wiring extends along the first direction and arranged along the second direction.

16. The touch display panel as claimed in claim 13, wherein an insulation layer is formed between the first electrode and the conductive bridge adjacent to the first electrode, to insulate the first electrode and the conductive bridge from each other.

17. The touch display panel as claimed in claim 13, wherein the first electrode, the second electrode and the conductive bridge are all grid structures.

18. A display device, comprising a touch display panel, which includes:
a substrate;
multiple electrodes disposed on the substrate; and
a driver chip; the electrode being connected to the driver chip by a wiring, wherein at least part of the wiring and the electrode are located in different layers.

19. The display device as claimed in claim 18, wherein a projection of the part of the wiring on the substrate coincides with that of the electrode on the substrate.

20. The display device as claimed in claim 19, wherein the electrodes includes multiple first electrodes and multiple second electrodes; the multiple first electrodes are electrically connected in a first direction to form a first electrode chain; the multiple second electrodes are electrically connected in a second direction to form a second electrode chain; the wiring includes a first wiring and a second wiring;
the first electrode chain and the second electrode chain are crossed;
wherein the first electrode chain is connected to the driver chip by the first wiring; the second electrode chain is connected to the driver chip by the second wiring; and the first wiring and the first electrode are located in different layers.
